(19) United States
(12) Patent Application Publication
(10) Pub. No.: US 2004/0062697 A1
(43) Pub. Date: Apr. 1, 2004

(54) Flue gas purification method

(75) Inventors: Murray Mortson, Calgary (CA); Joe Bichel, Calgary (CA); Stephen Schaaf, Calgary (CA); Dennis Johnson, Calgary (CA)

Correspondence Address: OGILVY RENAULT, 1981 MCGILL COLLEGE AVENUE, SUITE 1600, MONTREAL, QC, H3A2Y3, CA

(73) Assignee: Airborne Pollution Control Inc., Calgary, AB (CA)

(21) Appl. No.: 10/260,465

(22) Filed: Oct. 1, 2002

(51) Int. Cl. B01D 53/60

(52) U.S. Cl. 423/235

(57) ABSTRACT

A method of scrubbing SOₓ, NOₓ compounds and other air toxins from a flue gas stream. In the method, two distinct unit operations are amalgamated to scrub SOₓ, NOₓ and other air toxins compounds from a flue gas stream. More specifically, there is a dry scrubbing operation and a wet scrubbing operation. The dry injection scrubbing operation involves contacting a flue gas stream containing SOₓ and NOₓ compounds with a sorbent for removing substantially all of the SOₓ and NOₓ compounds present in the stream. The second wet scrubbing operation involves contacting the stream to remove any residual SOₓ, NOₓ compounds, and other air toxins remaining in the stream.

### CROSS-REFERENCE TO RELATED APPLICATIONS

This is the first application filed for the present invention.

### TECHNICAL FIELD

The present invention relates to a flue gas purification method, and more particularly, the present invention relates to a flue gas purification method incorporating dry injection and wet scrubbing unit operations to substantially eliminate SOₓ and NOₓ compounds as well as other air toxic compounds from the flue gas.

### BACKGROUND OF THE INVENTION

In view of new stringent legislation in the United States and elsewhere, greater strides have now had to be made concerning fossil fuels. As is well known, the use of fossil fuels significantly contributes to air pollution and a multitude of patents have issued with the objective of mitigating the pollution aspect.

Globally, the prior art establishes a number of wet chemical absorption methods which primarily incorporate wet scrubbers where a hot contaminated gas is scrubbed or detoxified in a gas liquid contact apparatus with a neutralizing solution. The neutralizing solution can typically be any suitable aqueous alkaline liquid or slurry to remove sulfur oxides and other contaminants present in the flue gas stream. The gas liquid contacts apparatus are generally employed by power generating stations and use the wet chemical absorption arrangement incorporating sodium, calcium, magnesium, etc. to desulfurize flue gas.

Generally typical of the issued references is U.S. Pat. No. 5,082,586, issued Jan. 21, 1992, to Hooper. In the document, a pollution control reagent compound is provided. The composition includes Nahcolite and urea for dry injection into a flue gas duct. This results in the reaction of Nahcolite with the SO₂ in the flue gas, while the urea precludes the synthesis of NO from NO₂ by the Nahcolite and regulates the NO₂ concentration in the exit gas to approximately 50 ppm. This limit is essentially the visibility limit.

In U.S. Pat. No. 5,002,741, issued to Hooper, Mar. 26, 1991, a further pollution control method is set forth. The process involves high carbon injection into flue gas together with a sodium based sorbent. The composition removes SOₓ and NOₓ compounds. As in the previously discussed reference, there is a specific concern for NO conversion to NO₂. In this case, the discussion indicates that the carbon material must have sufficiently high surface area and be mixed with a carrier such as flyash in order to retard the formation of the NO₂.

Johnson et al., in U.S. Pat. No. 6,303,083, issued Oct. 16, 2001, disclose a SOₓ removal process for flue gas treatment. A specific particle size range for the sorbent is reacted with the flue gas to reduce SO₃ content. The treated flue gas is then reacted in a wet scrubber to reduce SO₂ content.

A further wet scrubbing system is discussed in U.S. Pat. No. 4,263,021, issued Apr. 21, 1981 to Downs et al. The reference teaches a countercurrent gas/liquid contact method between flue gas containing sulfur dioxide and an aqueous slurry solution. The arrangement recognized in the art as a tray or gas distribution device. The tray has the purpose of improving the scrubber performance.

With respect to the wet precipitators, U.S. Pat. No. 4,441,897, issued Apr. 10, 1984 to Young et al., have been used for many years to remove sulfur trioxide from wet flue streams. In the principal of operation, the sulfur trioxide forms an aerosol of sulfuric acid by reaction with water. The aerosol is charged electrically, but subsequently removed by collection on plates or tubes. This process is also referred to as wet electrostatic precipitation.

Further processes which have been incorporated in industry to remove sulfur trioxide include condensation reactions. An example of such a process is referred to as the WSA-SNOX process. This method involves the catalytic conversion of sulfur dioxide to sulfur trioxide. The sulfur trioxide is then removed by condensation in the form of sulfur acid.

One problem which has beleaguered the industry is the control of brown plume, a consequence of flue gas purification. To this end, U.S. Pat. No. 4,954,324, issued to Hooper, Sep. 4, 1990, provides a process for baghouse brown plume control where urea or ammonia together with sodium bicarbonate or Nahcolite are injected. This dry injection procedure reacts the sodium bicarbonate with SO₂ to form sodium sulphate and removes NOₓ in the NO form. Urea impedes the conversion of NO to NO₂.

As is evident from the existing flue gas management protocols, NO and NOₓ formation present complications in terms of plume control. Consequently, the existence of the plume requires additional unit operations and still results in the existence of the plume at tolerable levels.

The wet scrubbing systems that employ lime, lime stone, soda ash or other alkaline compositions demonstrate efficacy for removal of sulfur dioxide, but are significantly less efficient at the removal of sulfur trioxide or sulfuric acid aerosol.

In terms of electrostatic precipitators, the wet type are useful to remove particulates and sulfur trioxide (as sulfuric acid and other aerosols), but such systems fall short on sulfur dioxide removal. Accordingly, there is a requirement for injection of absorbents, reagents or sorbents to control sulfur trioxide and sulfur dioxide, but the reagent requirement is significant. In an effort to combat the weaknesses of each system, a combination of wet flue gas desulfurization and wet electrostatic precipitation has been proposed and is effective at controlling both sulfur dioxide and sulfur trioxide, however, the electrostatic precipitator, in view of its design is limited in that the device required multiple stages to control sulfur trioxide at concentrations between 10 and 50 ppm. As is known in the art, these multiple stage arrangements are not only expensive and impractical, but they also pose engineering challenges and require a great deal of support equipment.

In light of the increasing stringent pollution regulations, there clearly exists a need for the management of flue gas where both the SOₓ and NOₓ compounds can be handled effectively without emission of brown plume, the need to augment with suppressants or the combination of equipment which, in the case of the wet flue gas desulfurization and wet electrostatic precipitation, only marginally addresses the problem at a fairly significant expense.

The methodology set forth herein alleviates all of the limitations in the prior art techniques.

### SUMMARY OF THE INVENTION

One object of the present invention is to provide an improved method for flue gas purification.

A further object of one embodiment of the present invention is to provide a method of scrubbing SOₓ and NOₓ compounds from a flue gas stream, comprising:

a dry injection scrubbing operation and a wet scrubbing operation, the dry injection scrubbing operation including:

contacting a flue gas stream containing SOₓ and NOₓ compounds with a sorbent for removing substantially all of the SOₓ and a large amount of NOₓ compounds present in the stream; and the wet scrubbing operation including:

contacting the stream to remove any residual SOₓ and NOₓ compounds remaining in the stream.

The unification of the dry injection scrubbing operation and a wet scrubbing operation advantageously eliminates the concern for brown plume. Previously, reaction of the sodium sorbents resulted in the synthesis of NOₓ compounds as plume. The NOₓ compounds are soluble species and are easily managed by treatment with the wet scrubbing operation. In this manner, it is immaterial that NO₂ forms; the plume cannot develop since the NOₓ (where x=>1 and Y=>2) species are absorbed in the wet scrubber. Accordingly, the previous requirement for auxiliary suppressant addition is obviated.

In the combined system set forth herein, the flue gas is preconditioned by absorbent injection. The absorbent can comprise suitable reagents or sorbents known to at least diminish the concentration of the sulfur trioxide. Advantageously, this can be achieved by wet or dry injection with essentially any sorbent or combinations of sorbent and at any possible location in the system. Dry sodium bicarbonate injection has been found to be particularly effective since it reacts with the sulfur di- and trioxides as well as the NOₓ compounds. Generally speaking, the sulfur trioxide is managed to a level that is compatable with single stage wet electrostatic precipitators installed in a wet flue gas desulfurization tower.

A further object of one embodiment of the presentation is to provide a method of scrubbing SOₓ and NOₓ compounds from a flue gas stream, comprising:

a dry injection scrubbing operation and a wet scrubbing operation, the dry injection scrubbing operation including:

contacting a flue gas stream containing SOₓ and NOₓ compounds with a sorbent for removing substantially all of the SOₓ and a large amount of NOₓ compounds present in the stream;

the wet scrubbing operation including:

contacting the stream to remove any residual SOₓ and NOₓ compounds remaining in the stream; and

recirculating unreacted sorbent to the wet scrubbing operation.

A still further object of one embodiment of the present invention is to provide a method of scrubbing SOₓ and NOₓ compounds from a flue gas stream, comprising:

a dry injection scrubbing operation and a wet scrubbing operation, the dry injection scrubbing operation including:

contacting a flue gas stream containing SOₓ and NOₓ compounds with a sorbent for removing substantially all of the SOₓ and a large amount of NOₓ compounds present in the stream; and

the wet scrubbing operation including:

scrubbing the stream from the dry injection scrubbing operation in the presence of an oxidant to remove any residual SOₓ and NOₓ compounds remaining in the stream.

As a particular benefit, the processes set forth herein are useful to capture air toxics including, as examples, mercury, particulates and a host of heavy metals.

As set forth herein previously, prior art attempts relating to the conversion of NO₂ were problematic since a brown plume of NO₂ was not captured by downstream equipment. By the combination of the technology set forth herein, the wet scrubbing operation efficiently captures the NO₂, N₂O₃ and N₂O₅ and other NₓO_{y} compounds. In addition, at least a portion of the NO is captured by the sodium bicarbonate.

Yet another object of one embodiment of the present invention is to provide a method of scrubbing SOₓ and NOₓ compounds from a flue gas stream, comprising:

a wet injection scrubbing operation and a wet scrubbing operation, the wet injection scrubbing operation including:

contacting a flue gas stream containing SOₓ and NOₓ compounds with a sorbent solution for removing substantially all of the SOₓ and a large amount of NOₓ compounds present in the stream; and

the wet scrubbing operation including:

contacting the stream to remove any residual SOₓ and NOₓ compounds remaining in the stream.

The provision of the oxidant augments the effectiveness of the wet scrubbing and in particular, the oxidation of the NOₓ compounds.

With respect to the apparatus, the existing technology has been effectively employed and choice for specific components will be readily apparent to the man skilled in the art.

Having thus generally described the invention, reference will now be made accompanying drawings, illustrating preferred embodiments.

### BRIEF DESCRIPTION OF THE DRAWINGS

FIG. 1 is a schematic illustration of a vertical combustor facility used to generate test data; and

FIG. 2 is a schematic illustration of the process according to one embodiment.

It will be noted that throughout the appended drawings, like features are identified by like reference numerals.

### DETAILED DESCRIPTION OF THE PREFERRED EMBODIMENTS EXPERIMENTAL

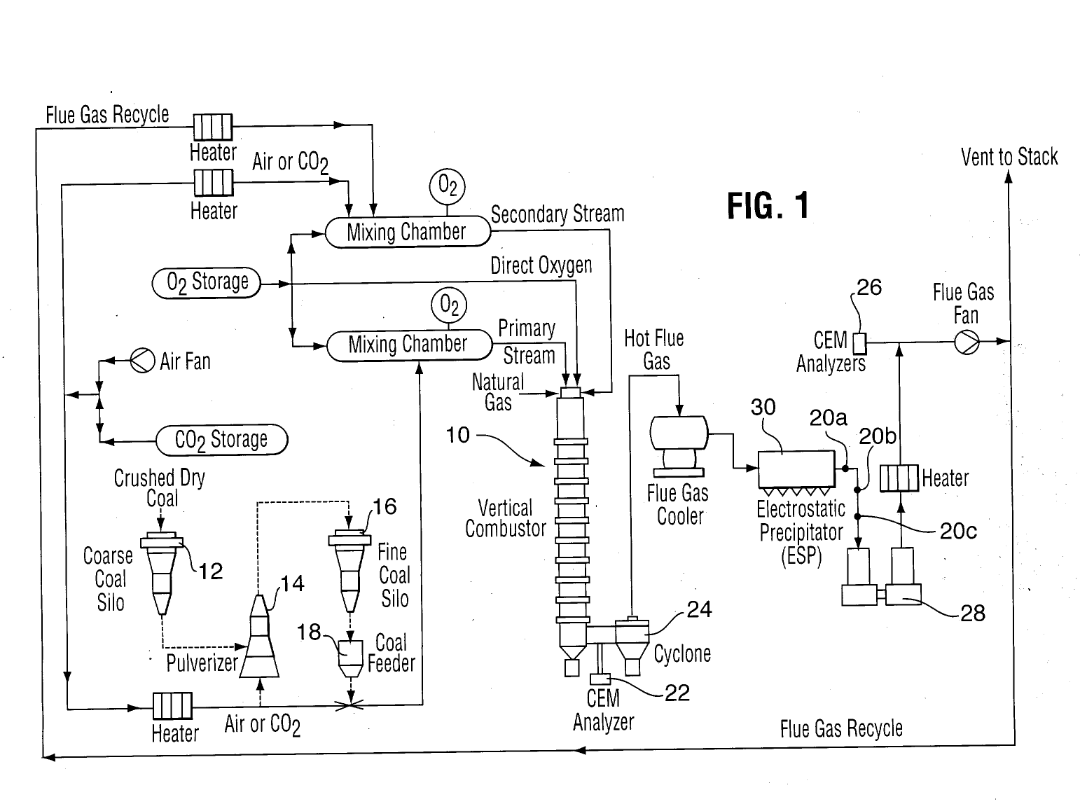

The apparatus employed to gather the data is illustrated in FIG. 1. The vertical combustor, globally denoted by numeral 10, was the primary combustor for generating the data.

Bituminous coal from silo 12 was pulverized in pulverizer 14 and passed on to silo 16 and subsequently into coal feeder 18. Pre-dried and pulverized coal was conveyed to the combustor via an eductor 20.

The combustor 10 produced NOₓ emissions of about 400-500 ppmdv at 2% O₂ excess at the combustor exit and SOₓ emissions at 2700 to 3000 ppm.

Flue gas compositions (O₂, CO₂, CO, NO and NO₂) were monitored using flue gas analyzer 22 located between the combustor 10 and cyclone 24.

For emission control, the combustor 10 was equipped with a hot cyclone, a five-field electrostatic precipitator (ESP) 30 and the condensing heat exchanger 28 (used as a wet scrubber).

Dry NaHCO₃ powder was injected against the flue stream in a counter current manner in ports 20a, 20b, and 20c.

Table 1 sets forward the conditions under which the data was obtained.

TABLE 1
Conditions Common to All Tests

| | |
|---|---|
| Coal | Bituminous |
| Heat input | 0.21 MWth (0.7 MBTU/hr) |
| Target O₂ excess in flue gas | 2% volume dry |
| Target NOₓ concentration | 400 ppmdv |
| Flue gas velocity at 150° C. | ˜3.4 m/s (11 ft/sec) |
| Scrubbing solution flow rate | ˜341/min (9 USGPM) |
| NaHCO3 injection duration | 1 hour, |
| NaHCO₃ in-flight residence | 0.5, 1.5 and 3 sec |
| time | |
| NaHCO₃ injection temperature | 150° C. |

Conditions Specific to Each Test

| | NaHCO₃ Injection | | Scrubbing |
|---|---|---|---|
| Test ID | Rate | NaHCO₃ Size | Solution |
| _0 | 6.6 kg/hr | 45 μm | Na₂CO₃ |
| _1 | 6.6 kg/hr | 20 μm | Pre-charged |
| _2 | 5.5 kg/hr | 20 μm | Pre-charged |
| _3 | 7.7 kg/hr | 20 μm | Pre-charged |

Injection Port

| Port ID | Residence time from Port to inlet (sec) |
|---|---|
| 20a | 3 |
| 20b | 1.5 |
| 20c | 0.5 |

Test _{—}0 was a base test to ensure that all components were operational. In this test, the NaHCO₃ was first injected in each port for 5 min. Then, a 1-hour long injection was done in Port 20a.

The scrubber pre-charging was done according to the following specifications: 1 kg of Na₂CO₃, 29 kg of Na₂SO₄ and 19 kg of Na₂SO₃ dissolved in 187 l of water. The pH of the prepared solution was about 10.6.

Table 2 represents the analysis of the coal used.

TABLE 2
Coal analysis
Proximate Analysis (wt %)

| | |
|---|---|
| Moisture | 1.14 |
| Ash | 11.03 |
| Volatiles | 39.3 |
| Fixed Carbon | 48.53 |

Ultimate Analysis (wt %, dry)

| | |
|---|---|
| Carbon | 72.42 |
| Hydrogen | 4.99 |
| Nitrogen | 1.37 |
| Sulphur | 3.96 |
| Ash | 11.03 |
| Oxygen (diff) | 6.10 |
| Chlorine (Cl) | 790 ppm |
| Fluorine (F) | 72 ppm |
| Mercury (Hg) | 0.086 ppm |

All combustion trials were conducted at a firing rate of 0.21 MWt (0.7 MBTU/hr) with the O₂ in flue gas being maintained at 2% dv.

Prior to commencing each suite of combustion trials with a specific coal, natural gas was burned at 0.3 MWt for at least 8 h with 5 vol % O₂ in the flue gas to perform instrumentation checks and to attain thermal equilibrium in the combustor 10 and downstream heat exchanger 28.

### EXAMPLE 1

NaHCO₃ was injected at 150° C. for a short period (5 minutes) in all three ports 20a, 20b, 20c at a rate of 6.6 kg/hr to observe its effects on the concentrations of SO₂ and NOₓ. A 1-hour continuous injection was then performed in Port 20a following the short injections.

Sodium carbonate (Na₂CO₃) in water solution was used in scrubber 28 as the scrubbing solution and was added during the testing period to maintain the solution pH at around 7.

Table 3 summarizes the average flue gas compositions at the combustor exit and scrubber inlet before any NaHCO₃ injection was made.

TABLE 3
Flue gas compositions before injections

| | Combustor Exit | Scrubber inlet |
|---|---|---|
| O₂ (%) | 2.08 ± 0.32 | 5.41 ± 0.22 |
| CO₂ (%) | 16.21 ± 0.38 | 13.65 ± 0.26 |
| CO (ppm) | 50 ± 154 | 100 ± 142 |
| NOₓ (ppm) | 493 ± 54 | 226 ± 24 |
| SO₂ (ppm) | 2854 ± 114 | 2331 ± 58 |

Note that all concentrations are reported on a volumetric and dry basis.

Injection of sodium bicarbonate started at 0240 pm at Port 20c (0.5 sec residence time), then proceeded to Ports 20b and 20a lasting for 5 min at each port. Table 4 summarizes the flue gas compositions during the injection period.

TABLE 4
Flue gas compositions at combustor exit and
scrubber inlet during the short period (5 min) sorbent
injections

| | Port 20c | | Port 20b | | Port 20a | |
|---|---|---|---|---|---|---|
| | Comb. | Scrubber | Comb. | Scrubber | Comb. | Scrubber |
| | Exit | inlet | Exit | inlet | Exit | inlet |
| O₂ (%) | 2.6 ± 0.4 | 7.2 ± 0.5 | 2.3 ± 0.3 | 7.1 ± 0.3 | 2.3 ± 0.2 | 6.9 ± 0.1 |
| CO₂ (%) | 15.6 ± 0.4 | 11.9 ± 0.3 | 16.3 ± 0.3 | 12.0 ± 0.2 | 16.1 ± 0.0 | 12.4 ± 0.0 |
| CO (ppm) | 35 ± 30 | 67 ± 78 | 15 ± 26 | 28 ± 24 | 8 ± 3 | 19 ± 9 |
| NOₓ (ppm) | 491 ± 13 | 204 ± 11 | 488 ± 13 | 193 ± 13 | 512 ± 10 | 162 ± 7 |
| SO₂ (ppm) | 2687 ± 96 | 1637 ± 117 | 2853 ± 30 | 1570 ± 97 | 2919 ± 57 | 1344 ± 44 |

Table 5 shows the flue gas compositions during the 1-hour injection in Port 20a:

TABLE 5
Flue gas compositions at combustor exit, scrubber
inlet and outlet during the 1-hour sorbent injections in
Port 20a

| | | Scrubber | Scrubber |
|---|---|---|---|
| | Comb. Exit | Inlet | Outlet |
| O₂ (%) | 2.3 ± 0.2 | 6.9 ± 0.1 | 7.0 ± 0.3 |
| CO₂ (%) | 16.1 ± 0.3 | 12.3 ± 0.2 | 12.4 ± 0.2 |
| CO (ppm) | 30 ± 107 | 36 ± 80 | 10 ± 1 |
| NOₓ (ppm) | 515 ± 19 | 152 ± 11 | 170 ± 7 |
| SO₂ (ppm) | 2862 ± 42 | 1115 ± 45 | 15 ± 2 |

A significant reduction in concentration of the SO₂ and NOₓ was realized immediately upon injection of the NaHCO₃ into the flue gas stream. The effect was enhanced with increasing residence time. Once the NaHCO₃ injection was complete, the concentrations of SO₂ and NOₓ returned to pre-injection levels.

A further test was done with NaHCO₃ injection in three ports at a flow rate of 6.6 kg/hr and target injection temperature of 150° C. The injection period lasted 1 hour in each port.

The NaHCO₃ injection started in Port 20c and proceeded to Ports 20b and 20a.

Table 6 summarizes the average flue gas compositions at the combustor exit and scrubber inlet before any NaHCO₃ injection was made.

TABLE 6
Flue gas compositions before injections

| | Combustor Exit | Scrubber inlet |
|---|---|---|
| O₂ (%) | 1.87 ± 0.44 | 4.48 ± 0.49 |
| CO₂ (%) | 16.42 ± 0.42 | 14.11 ± 0.41 |
| CO (ppm) | 27 ± 109 | 46 ± 56 |
| NOₓ (ppm) | 492 ± 47 | 408 ± 36 |
| SO₂ (ppm) | 2969 ± 68 | 2591 ± 157 |

Injection of NaHCO₃ started at 1254 am at Port 20c (0.5 sec residence time), proceeded to Ports 20b and 20a and lasted for 60 min in each port. Table 7 summarizes the flue gas compositions during the injections.

TABLE 7
Flue gas compositions during injections

| | | |
|---|---|---|
| Scrubber inlet | | |
| before injection | Scrubber inlet | Scrubber outlet |
| (diluted by | during | during |
| injection air) | injection | injection |

Port 20c

| | | | |
|---|---|---|---|
| O₂ (%) | 6.10 ± 0.47 | 5.68 ± 0.18 | 5.66 ± 0.12 |
| CO₂ (%) | 13.35 ± 0.44 | 13.41 ± 0.28 | 13.37 ± 0.09 |
| CO (ppm) | 45 ± 47 | 97 ± 142 | 36 ± 44 |
| NO (ppm) | 356 ± 18 | 215 ± 13 | 252 ± 13 |
| NO₂ (ppm) | 6 ± 2 | 27 ± 4 | 4 ± 2 |
| NOₓ (ppm) | 362 ± 21 | 242 ± 12 | 256 ± 15 |
| SO₂ (ppm) | 2385 ± 64 | 296 ± 30 | 11 ± 2 |

Port 20b

| | | | |
|---|---|---|---|
| O₂ (%) | 5.71 ± 0.45 | 5.67 ± 0.14 | 5.68 ± 0.17 |
| CO₂ (%) | 13.46 ± 0.48 | 13.67 ± 0.00 | 13.50 ± 0.00 |
| CO (ppm) | 43 ± 45 | 43 ± 71 | 23 ± 23 |
| NO (ppm) | 317 ± 24 | 182 ± 13 | 202 ± 13 |
| NO₂ (ppm) | 8 ± 2 | 41 ± 3 | 6 ± 4 |
| NOₓ (ppm) | 325 ± 24 | 223 ± 12 | 208 ± 13 |
| SO₂ (ppm) | 2167 ± 204 | 245 ± 34 | 18 ± 4 |

Port 20a

| | | | |
|---|---|---|---|
| O₂ (%) | 5.96 ± 0.05 | 5.74 ± 0.12 | 5.80 ± 0.19 |
| CO₂ (%) | 13.07 ± 0.00 | 13.54 ± 0.27 | 13.41 ± 0.00 |
| CO (ppm) | 13 ± 0 | 21 ± 32 | 14 ± 11 |
| NO (ppm) | 344 ± 21 | 113 ± 11 | 118 ± 12 |
| NO₂ (ppm) | 14 ± 3 | 76 ± 5 | 11 ± 5 |
| NOₓ (ppm) | 358 ± 21 | 189 ± 12 | 128 ± 14 |
| SO₂ (ppm) | 2282 ± 38 | 160 ± 16 | 11 ± 3 |

As is evident, a noticeable decrease of NO and SO₂ upon the injection of NaHCO₃ and the increase of NO₂ was realized. The scrubber was very effective at removing SO₂ as its concentration dropped precipitously at the scrubber outlet.

### EXAMPLE 2

This test was done with NaHCO₃ injection in three ports at a flow rate of 5.5 kg/hr and injection temperature of 150° C. The injection period was 1 hour in each port. The scrubber solution was pre-charged with: 1 kg of Na₂CO₃, 29 kg of Na₂SO₄ and 19 kg of Na₂SO₃ dissolved in 187 l of water. The pH of the prepared solution was about 10.6.

The NaHCO₃ injection started in Port 20c and proceeded to Ports 20b and 20a. After the completion of each injection, the filter of the CEM train downstream of the injection port was immediately changed to ensure accurate readings of the flue gas compositions.

Table 8 summarizes the average flue gas compositions at the combustor exit and scrubber inlet before any NaHCO₃ injection was made.

TABLE 8
Flue gas compositions before injections

| | Combustor Exit | Scrubber inlet |
|---|---|---|
| O₂ (%) | 2.07 ± 0.30 | 4.28 ± 0.34 |
| CO₂ (%) | 16.17 ± 0.30 | 14.52 ± 0.33 |
| CO (ppm) | 10 ± 46 | 21 ± 24 |
| NOₓ (ppm) | 515 ± 57 | 321 ± 27 |
| SO₂ (ppm) | 2937 ± 86 | 2438 ± 77 |

Injection of NaHCO₃ started at 1237 am at Port 20c (0.5 sec residence time), proceeded to Port 20a lasting for 60 min at each port. Table 9 summarizes the flue gas compositions during the injections.

TABLE 9
Flue gas compositions during injections

| | | |
|---|---|---|
| Scrubber inlet | | |
| before injection | Scrubber inlet | Scrubber outlet |
| (diluted by | during | during |
| injection air) | injection | injection |

Port 20c

| | | | |
|---|---|---|---|
| O₂ (%) | 6.18 ± 0.63 | 6.05 ± 0.14 | 6.21 ± 0.16 |
| CO₂ (%) | 13.84 ± 0.44 | 13.48 ± 0.26 | 13.41 ± 0.10 |
| CO (ppm) | 87 ± 151 | 17 ± 11 | 12 ± 12 |
| NO (ppm) | 277 ± 33 | 203 ± 22 | 211 ± 23 |
| NO₂ (ppm) | 0 ± 0 | 5 ± 3 | 7 ± 4 |
| NOₓ (ppm) | 277 ± 33 | 208 ± 21 | 218 ± 24 |
| SO₂ (ppm) | 2208 ± 70 | 159 ± 21 | 11 ± 2 |

Port 20b

| | | | |
|---|---|---|---|
| O₂ (%) | 6.18 ± 0.24 | 6.26 ± 0.13 | 6.49 ± 0.14 |
| CO₂ (%) | 12.94 ± 0.28 | 13.23 ± 0.09 | 13.23 ± 0.22 |
| CO (ppm) | 30 ± 65 | 10 ± 9 | 6 ± 1 |
| NO (ppm) | 280 ± 15 | 150 ± 23 | 181 ± 21 |
| NO₂ (ppm) | 4 ± 2 | 45 ± 4 | 1 ± 2 |
| NOₓ (ppm) | 284 ± 16 | 195 ± 26 | 183 ± 22 |
| SO₂ (ppm) | 2364 ± 68 | Decreasing to | 90 ± 9 |
| | | 150 | |

Port 20a

| | | | |
|---|---|---|---|
| O₂ (%) | 6.37 ± 0.17 | 6.36 ± 0.11 | 6.35 ± 0.16 |
| CO₂ (%) | 12.88 ± 0.23 | 12.96 ± 0.20 | 13.45 ± 0.00 |
| CO (ppm) | 13 ± 18 | 10 ± 11 | 12 ± 18 |
| NO (ppm) | 320 ± 35 | 113 ± 9 | 125 ± 12 |
| NO₂ (ppm) | 10 ± 3 | 58 ± 3 | 2 ± 3 |
| NOₓ (ppm) | 330 ± 36 | 171 ± 12 | 128 ± 12 |
| SO₂ (ppm) | 2303 ± 39 | 326 ± 24 | 18 ± 3 |

From a review of the data noted above, there was a noticeable decrease of NO and SO₂ upon the injection of NaHCO₃ and a significant increase of NO₂ at scrubber inlet at 1 and 3 sec residence time. When the CEM was moved to scrubber outlet at the end of the third injection, it indicated the immediate increase of the concentrations of NO₂ and SO₂ confirming their removal in the scrubber.

### EXAMPLE 3

In the example, NaHCO₃ injection occurred in three ports at a flow rate of 7.7 kg/hr and injection temperature of 150° C. The injection period lasted 1 hour in each port. The scrubber solution was pre-charged as 1 kg of Na₂CO₃, 29 kg of Na₂SO₄ and 19 kg of Na₂SO₃ dissolved in 187 l of water. The pH of the prepared solution was about 10.6.

The NaHCO₃ injection started in Port 20c and proceeded to Port 20a.

Table 10 shows the average injection temperatures for each port.

TABLE 10
Average injection temperatures (° C.)

| | Port 20a | | Port 20b | | Port 20c | |
|---|---|---|---|---|---|---|
| | Up- | Down- | Up- | Down- | Up- | Down- |
| | stream | stream | stream | stream | stream | stream |
| Injection | 155 ± 3 | 132 ± 5 | 157 ± 1 | 133 ± 0 | 157 ± 5 | 139 ± 5 |
| temperature | | | | | | |

Table 11 summarizes the average flue gas compositions at the combustor exit and scrubber inlet before any NaHCO₃ injection was made.

TABLE 11
Flue gas compositions before injections

| | Combustor Exit | Scrubber inlet |
|---|---|---|
| O₂ (%) | 2.14 ± 0.33 | 4.38 ± 0.19 |
| CO₂ (%) | 15.95 ± 0.29 | 14.23 ± 0.45 |
| CO (ppm) | 10 ± 85 | 28 ± 5 |
| NOₓ (ppm) | 545 ± 114 | 540 ± 25 |
| SO₂ (ppm) | 2964 ± 127 | 2672 ± 101 |

Injection of sodium bicarbonate started at 1237 am at Port C (0.5 sec residence time), proceeded to Port A lasting for 60 min at each port.

Table 12 summarizes the flue gas compositions during the injections.

TABLE 12
Flue gas compositions during injections

| | | |
|---|---|---|
| Scrubber inlet | | |
| before injection | Scrubber inlet | Scrubber outlet |
| (diluted by | during | during |
| injection air) | injection | injection |

Port 20c

| | | | |
|---|---|---|---|
| O₂ (%) | 5.82 ± 0.38 | 6.05 ± 0.10 | 6.11 ± 0.16 |
| CO₂ (%) | 12.89 ± 0.38 | 13.25 ± 0.00 | 13.02 ± 0.17 |
| CO (ppm) | 20 ± 1 | 17 ± 1 | 14 ± 1 |
| NO (ppm) | 480 ± 54 | 303 ± 28 | 341 ± 19 |
| NO₂ (ppm) | 7 ± 5 | 38 ± 4 | 6 ± 2 |
| NOₓ (ppm) | 486 ± 61 | 342 ± 34 | 346 ± 20 |
| SO₂ (ppm) | 2464 ± 57 | Decreasing to | 12 |
| | | 130 | |

Port 20b

| | | | |
|---|---|---|---|
| O₂ (%) | 5.98 ± 0.22 | 5.85 ± 0.11 | 5.79 ± 0.10 |
| CO₂ (%) | 13.05 ± 0.22 | 13.45 ± 0.16 | 13.22 ± 0.00 |
| CO (ppm) | 15 ± 2 | 17 ± 36 | 15 ± 15 |
| NO (ppm) | 457 ± 7 | 275 ± 20 | 286 ± 19 |
| NO₂ (ppm) | 22 ± 3 | 58 ± 7 | 4 ± 1 |
| NOₓ (ppm) | 479 ± 7 | 333 ± 23 | 290 ± 19 |
| SO₂ (ppm) | 2303 ± 58 | 300-400 | 10 ± 1 |

Port 20a

| | | | |
|---|---|---|---|
| O₂ (%) | 5.67 ± 0.32 | 5.86 ± 0.08 | 5.74 ± 0.12 |
| CO₂ (%) | 13.23 ± 0.27 | 13.36 ± 0.03 | 13.31 ± 0.15 |
| CO (ppm) | 25 ± 25 | 11 ± 3 | 13 ± 8 |
| NO (ppm) | 510 ± 12 | 224 ± 13 | 202 ± 8 |
| NO₂ (ppm) | 26 ± 6 | 88 ± 3 | 3 ± 2 |
| NOₓ (ppm) | 536 ± 11 | 312 ± 14 | 206 ± 7 |
| SO₂ (ppm) | 2303 ± 39 | 218 ± 16 | 8 ± 1 |

There was a decrease of NO and SO₂ upon the injection of NaHCO₃ and a pronounced increase of NO₂ at the scrubber inlet at all 3 residence times tested. Accordingly, at this injection rate (7.7 kg/hr), the accumulation of NaHCO₃ powder on the CEM filter was quite rapid. During the third injection at Port 20a, the CEM was first located at the scrubber outlet and moved to the scrubber inlet at the end of the injection in order to obtain a more reliable SO₂ reading.

The last 3 tests all showed that, upon injection of NaHCO₃ in the flue stream, concentrations of SO₂ and NO decreased immediately, while NO₂ concentration increased. Once the injection was stopped, the concentrations of SO₂ and NO rapidly returned to the pre-injection levels. The NaHCO₃ injection did not have any effect on the concentrations of the other monitored species (O₂, CO₂ and CO).

For all three tests, the scrubber solution was pre-charged according to 1 kg of Na₂CO₃, 29 kg of Na₂SO₄ and 19 kg of Na₂SO₃ dissolved in 187 l of water. The pH of the prepared solution was about 10.6. When the scrubbing started, the pH value decreased slowly as sulfur was dissolved in the solution. However, when the NaHCO₃ injection started, the pH value of the scrubbing solution stayed steady at about 7.5.

From Table 13, it can be seen that the scrubber was very effective in removing NO₂ produced in the flue stream after the injection of NaHCO₃. The scrubber was also very effective at removing SO₂.

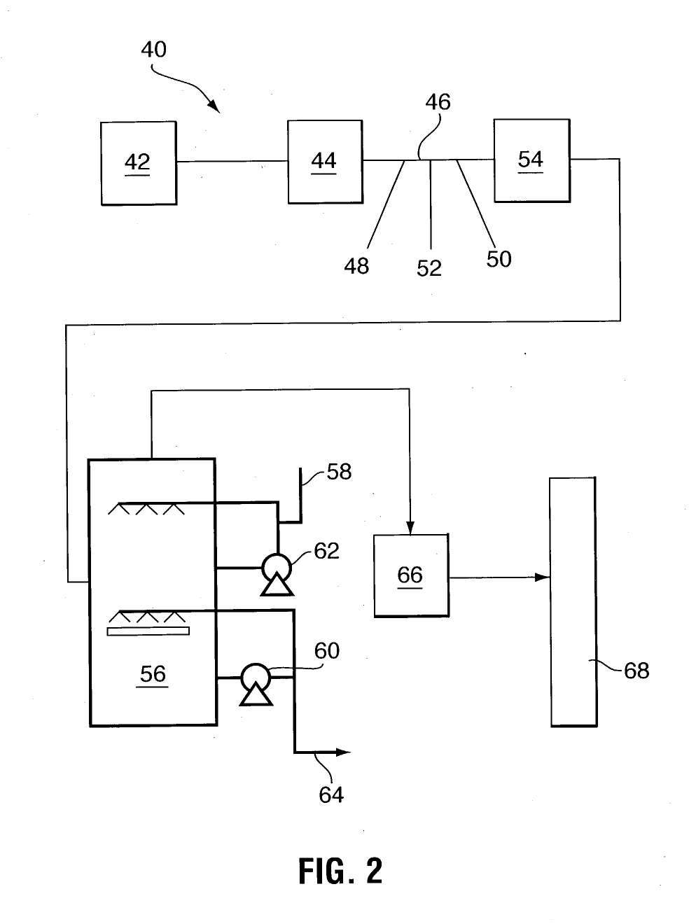

Having described the test facility and the data collected, in connection with establishing the effectiveness of the injection and scrubbing operations, reference will now be made to FIG. 2 which schematically illustrates one embodiment of a plant design. The overall plant design is referenced by numeral 40 with the combustion system from, for example, a power station being referenced by numeral 42. The combustion products are first treated in an electrostatic precipitator or baghouse 44 and subsequently discharged through a flue gas duct 46. In an attempt to further increase the efficiency of the overall system, oxidant material may be injected into the flue gas duct at any number of locations such as at or approximate the inlet 48 or approximate the outlet 50. At this oxidation step, is useful to convert uncaptured NO and NO₂ to be converted to NO₂, N₂O₃, N₂O₅ and NₓO_{y} inter alia. The oxidation steps 48 and 50 are augmented by the injection step with sodium bicarbonate, the injection being broadly denoted by numeral 52. Although the sodium bicarbonate injection step is preferentially a dry injection step, it will be clearly understood by those skilled in the art that the injection step can also be wet with essentially any alkali compound and at any of several locations from the flue gas duct to the wet scrubber to be discussed hereinafter.

Suitable oxidants will be appreciated by those skilled, however, examples include hydrogen peroxide, ozone, sodium chlorate or compounds (NaClOₓ where x is 1 through 4) or any combination of these materials. Once having been treated with a dry injection step, the flue gas stream now partially devoid of NOₓ compounds is treated in a wet to dry transition device 54 and then subsequently on to the wet scrubbing operation in wet scrubber 56. Any suitable scrubber 56 may be incorporated and will be essentially the choice of the designer based on the requirements of the overall circuit. Typical manufactures of wet scrubbers include The Babcock and Wilcox Company, Marsulex, Kawaski Heavy Industries, Mitsui, Chiyoda, Thyssen KEA, inter alia. Numerals 58 and 60 denote further possible oxidant injection points where the aqueous solution of the oxidant is recirculated into the scrubber 56. A suitable pump 62 may be included with each circulation loop of the oxidant. These steps are optional, since it has been indicated herein previously that the oxidant can be introduced at any point from the flue gas duct to the wet scrubber and still function to achieve the goal of oxidizing any compounds present. The solution from scrubber 56, broadly denoted by numeral 64 may be removed from time to time for processing.

As a further optional step, a wet electrostatic precipitator may be introduced into the circuit, the former being represented by numeral 66 where the gas stream is passed through the electrostatic precipitator to polish the flue gas of any further particulate, fine particulates, water droplets or aerosols from the stream. This is an optional step and is not essential to the process. Once through the ESP 66, the flue gas can then be discharged through the stack 68. The wet esp 66 may or may not be an extension to the wet scrubber 56. An alternative, shown in dashed lines is illustrated in FIG. 2.

In terms of the overall reactions that occur in the process, the reactions that occur in the dry injection phase are simply those that involve the sodium bicarbonate contacting the SOₓ and NOₓ compounds. Exemplary of the actions of the SOₓ chemistry that occur in the injection apparatus include the following:

1) NaHCO₃ [symbol] Na₂CO₃+CO₂(g)+H₂O(g)

2) 2*NaHCO₃+SO₂(g) [symbol] Na₂SO₃+2*CO₂(g)+H₂O(g)

3) 2*NaHCO₃+SO₃(g) [symbol] Na₂SO₄+2*CO₂(g)+H₂O(g)

4) Na₂CO₃+SO₂(g) [symbol] Na₂SO₃+CO₂(g)

5) Na₂CO₃+SO₃(g) [symbol] Na₂SO₄+CO₂(g)

6) 2*NaNO₃+SO₂(g) [symbol] Na₂SO₄+2*NO₂(g)

7) 2*NaNO₂+SO₂(g) [symbol] Na₂SO₄+2*NO(g)

8) 2*NaNO₂+SO₂(g)+O₂(g) [symbol] Na₂SO₄+2*NO₂(g)

9) SO₂(g)+H₂O [symbol] HSO₃+H

In addition to the SOₓ reactions there are additionally NOₓ reactions occurring in the injection phase which include the following:

1) Na₂SO₃+2*NO₂(g)+O₂(g) [symbol] 2*NaNO₃+SO₃(g)

2) Na₂SO₃+2*NO(g)+2*O₂(g) [symbol] 2*NaNO₃+SO₃(g)

3) Na₂SO₃+2*NO(g)+O₂(g) [symbol] 2*NaNO₂+SO₃(g)

4) Na₂CO₃+2*NO₂(g)+O₂(g) [symbol] 2*NaNO₃+NO(g)+CO₂(g)

5) 2*NO(g)+O₂(g) [symbol] 2*NO₂(g)

6) NO(g)+NO₂(g) [symbol] N₂O₃(g)

7) 2*NO₂(g) [symbol] N₂O₄(g)

8) N₂O₃(g)+H₂O [symbol] 2*HNO₂

9) N₂O₃(g)+2*NaOH [symbol] 2*NaNO₂+H₂O

10) 2*NO₂(g)+H₂O [symbol] HNO₂+HNO₃

11) 2*NO₂(g)+2*NaOH [symbol] NaNO₂+NaNO₃+H₂O

12) 3*NO₂(g)+H₂O [symbol] NO(g)+2*HNO₃

13) 3*NO₂(g) [symbol] N₂O₅(g)+NO(g)

14) NaNO₂+NO₂(g) [symbol] NO(g)+NaNO₃

15) N₂O₄(g)+H₂O [symbol] HNO₂+HNO₃

16) 3*HNO₂ [symbol] 2*NO(g)+H₂O+HNO₃

17) N₂O₅(g)+H₂O [symbol] 2*HNO₃

18) HNO₃+NaOH [symbol] NaNO₃+H₂O

In terms of the reactions that occur in the wet scrubber, many of the NOₓ reactions indicated above occur in the wet scrubbing phase as well as the following acid gas reactions:

1) 2*HCl+Na₂CO₃ [symbol] 2*NaCl+CO₂+H₂O

2) 2*HF+Na₂CO₃ [symbol] 2*NaF+CO₂+H₂O

3) H₂S+2*O₂ [symbol] H₂SO₄ [symbol] OH+HSO₃

4) Na₂S+2*O₂ [symbol] 2*Na₂SO₄

5) 8*NO(g)+Na₂S [symbol] NaSO₃(NO)₂+3*N₂O

6) NaSO₃(NO)₂+3*N₂O [symbol] NaSO₄+4*N₂O

7) H₂SO₄+Na₂CO₃ [symbol] Na₂SO₄+CO₂+H₂O

As discussed herein previously, the oxidant loops where oxidant is injected into the wet scrubber by points 58 and 60. Typical of the reactions that will occur from an oxidation point of view include the following:

1) O(g)+O₂(g) [symbol] O₃(g)

2) NO(g)+O₃(g) [symbol] NO₂(g)+O₂(g)

3) 2*NO(g)+O₃(g) [symbol] N₂O₅(g)

4) 2*NO(g)+O₂(g) [symbol] 2*NO₂(g)

5) 2*NO₂(g)+O₃(g)+H₂O [symbol] 2*HNO₃(g)+O₂(g)

6) NO(g)+NaClO [symbol] NaCl+NO₂(g)

7) H₂S+4*NaClO [symbol] 4*NaCl+H₂SO₄

8) H₂S+H₂O₂ [symbol] S+2*H₂O

9) 4*NO(g)+3*NaClO₂+4*NaOH [symbol] 4*NaNO₃+3*NaCl+2*H₂O

10) 4*NO₂(g)+NaClO₂+4*NaOH [symbol] 4*NaNO₃+NaCl+2*H₂O

11) 2*Na₂SO₃+NaClO₂ [symbol] 2*Na₂SO₄+NaCl

12) 3*H₂O₂+2*NO(g) [symbol] HNO₃+2*H₂O

13) H₂O₂+HNO2 [symbol] HNO₃+H₂O

As a particular convenience, the dry injection scrubbing operation as well as the wet scrubbing operation are particularly useful in reducing other air toxic compounds present in the flue gas.

Based on the Environmental Protection Agency in the United States, the listed air toxic compounds include the following:

Acetaldehyde

Acetamide

Acetonitrile

Acetophenone

2-Acetylaminofluorene

Acrolein

Acrylamide

Acrylic acid

Acrylonitrile

Allyl chloride

4-Aminobiphenyl

Aniline

o-Anisidine

Asbestos

Benzene (including benzene from gasoline)

Benzidine

Benzotrichloride

Benzyl chloride

Biphenyl

Bis(2-ethylhexyl)phthalate (DEHP)

Bis(chloromethyl) ether

Bromoform

1,3-Butadiene

Calcium cyanamide

Captan

Carbaryl

Carbon disulfide

Carbon tetrachloride

Carbonyl sulfide

Catechol

Chloramben

Chiordane

Chlorine

Chloroacetic acid

2-Chloroacetophenone

Chlorobenzene

Chlorobenzilate

Chloroform

Chloromethyl methyl ether

Chloroprene

Cresol/Cresylic acid (mixed isomers)

o-Cresol

m-Cresol

p-Cresol

Cumene

2,4-D, salts and esters (2,4-Dichlorophenoxyacetic

Acid)

DDE (1,1-dichloro-2,2-bis(p-chlorophenyl) ethylene)

Diazomethane

Dibenzofuran

1,2-Dibromo-3-chloropropane

Dibutyl phthalate

1,4-Dichlorobenzene

3,3′-Dichlorobenzidine

Dichloroethyl ether (Bis[2-chloroethyl]ether)

1,3-Dichloropropene

Dichlorvos

Diethanolamine

Diethyl sulfate

3,3′-Dimethoxybenzidine

4-Dimethylaminoazobenzene

N,N-Dimethylaniline

3,3′-Dimethylbenzidine

Dimethylcarbamoyl chloride

N,N-Dimethylformamide

1,1-Dimethylhydrazine

Dimethyl phthalate

Dimethyl sulfate

4,6-Dinitro-o-cresol (including salts)

2,4-Dinitrophenol

2,4-Dinitrotoluene

1,4-Dioxane (1,4-Diethyleneoxide)

1,2-Diphenylhydrazine

Epichlorohydrin (1-Chloro-2,3-epoxypropane)

1,2-Epoxybutane

Ethyl acrylate

Ethylbenzene

Ethyl carbamate (Urethane)

Ethyl chloride (Chloroethane)

Ethylene dibromide (Dibromoethane)

Ethylene dichloride(1,2-Dichloroethane)

Ethylene glycol

Ethyleneimine (Aziridine)

Ethylene oxide

Ethylene thiourea

Ethylidene dichloride (1,1-Dichloroethane)

Formaldehyde

Heptachlor

Hexachlorobenzene

Hexachlorobutadiene

1,2,3,4,5,6-Hexachlorocyclohexane (all stereo isomers, including lindane)

Hexachlorocyclopentadiene

Hexachloroethane

Hexamethylene diisocyanate

Hexamethylphosphoramide

Hexane

Hydrazine

Hydrochloric acid (Hydrogen Chloride)

Hydrogen fluoride (Hydrofluoric acid)

Hydroquinone

Isophorone

Maleic anhydride

Methanol

Methoxychlor

Methyl bromide (Bromomethane)

Methyl chloride (Chloromethane)

Methyl chloroform (1,1,1-Trichloroethane)

Methyl ethyl ketone (2-Butanone)

Methylhydrazine

Methyl iodide (Iodomethane)

Methyl isobutyl ketone (Hexone)

Methyl isocyanate

Methyl methacrylate

Methyl tert-butyl ether

4,4′-Methylenebis(2-chloroaniline)

Methylene chloride (Dichloromethane)

4,4′-Methylenediphenyl diisocyanate (MDI)

4,4′-Methylenedianiline

Naphthalene

Nitrobenzene

4-Nitrobiphenyl

4-Nitrophenol

2-Nitropropane

N-Nitroso-N-methylurea

N-Nitrosodimethylamine

N-Nitrosomorpholine

Parathion

Pentachloronitrobenzene (Quintobenzene)

Pentahlorophenol

Phenol

p-Phenylenediamine

Phosgene

Phosphine

Phosphorus

Phthalic anhydride

Polychlorinated biphenyls (Aroclors)

1,3-Propane sultone

beta-Propiolactone

Propionaldehyde

Propoxur (Baygon)

Propylene dichloride (1,2-Dichloropropane)

Propylene oxide

1,2-Propylenimine (2-Methylaziridine)

Quinoline

Quinone (p-Benzoquinone)

Styrene

Styrene oxide

2,3,7,8-Tetrachlorodibenzo-p-dioxin

1,1,2,2-Tetrachloroethane

Tetrachloroethylene (Perchloroethylene)

Titanium tetrachloride

Toluene

Toluene-2,4-diamine

2,4-Toluene diisocyanate

o-Toluidine

Toxaphene (chlorinated camphene)

1,2,4-Trichlorobenzene

1,1,2-Trichloroethane

Trichloroethylene

2,4,5-Trichlorophenol

2,4,6-Trichlorophenol

Triethylamine

Trifluralin

2,2,4-Trimethylpentane

Vinyl acetate

Vinyl bromide

Vinyl chloride

Vinylidene chloride (1,1-Dichloroethylene)

Xylenes (mixed isomers)

o-Xylene

m-Xylene

p-Xylene

Antimony Compounds

Arsenic Compounds (inorganic including arsine)

Beryllium Compounds

Cadmium Compounds

Chromium Compounds

Cobalt Compounds

Coke Oven Emissions

Cyanide Compounds

Glycol ethers

Lead Compounds

Manganese Compounds

Mercury Compounds

Fine mineral fibers

Nickel Compounds

Polycyclic Organic Matter

Radionuclides (including radon)

Selenium Compounds

In conclusion, by combining dry injection and wet scrubbing operations, the concentrations of SO₂ and NOₓ were reduced immediately primarily due to their respective chemical reactions with NaHCO₃. Other sorbents clearly will also provide effectiveness including the calcium and magnesium based sorbents such as calcium carbonate, calcium bicarbonate, calcium hydroxide, magnesium carbonate, magnesium bicarbonate, magnesium hydroxide or any combination of these.

Reference to U.S. Pat. Nos. 6,143,263 and 6,303,083 may be made for other examples in SOₓ removal.

The scrubber proved very effective at removing NO₂ which can account for a significant portion of the overall NOₓ; the scrubber was also effective in removing sulfuric compounds resulting in near zero SO₂ emission.

Although embodiments of the invention have been described above, it is not limited thereto and it will be apparent to those skilled in the art that numerous modifications form part of the present invention insofar as they do not depart from the spirit, nature and scope of the claimed and described invention.

We claim:

1. A method of scrubbing SOₓ and NOₓ compounds from a flue gas stream, comprising:
a dry injection scrubbing operation and a wet scrubbing operation, said dry injection scrubbing operation including:
contacting a flue gas stream containing SOₓ and NOₓ compounds with a sorbent for removing substantially all of the SOₓ and a large amount of NOₓ compounds present in said stream; and
said wet scrubbing operation including:
contacting said stream to remove any residual SOₓ and NOₓ compounds remaining in said stream.

2. The method as set forth in claim 1, wherein said sorbent is a sodium based sorbent selected from the group consisting of sodium bicarbonate, sodium carbonate, sodium hydroxide, or combinations thereof.

3. The method as set forth in claim 1, wherein said sorbent is a calcium based sorbent selected from the group consisting of calcium carbonate, calcium bicarbonate, calcium hydroxide and combinations thereof.

4. The method as set forth in claim 1, wherein said sorbent is a magnesium based sorbent selected from the group consisting of magnesium carbonate, magnesium bicarbonate, magnesium hydroxide and combinations thereof.

5. The method as set forth in claim 1, wherein said sorbent comprises a combination of sodium, magnesium and calcium sorbents.

6. The method as set forth in claim 1, wherein said dry injection scrubbing operation produces sodium sulfate, sodium sulfite, sodium fluoride, sodium chloride, sodium nitrite, sodium carbonate and/or sodium nitrate.

7. The method as set forth in claim 1, wherein said SOₓ and NOₓ compounds include SO₂, SO₃, NO₂, N₂O₃, N₂O₅, NₓO_{y} and dimers thereof.

8. The method as set forth in claim 1, further including the step of recirculating unreacted sorbent for use in said wet scrubbing operation.

9. The method as set forth in claim 1, wherein said method further includes the step of oxidizing said flue gas stream.

10. The method as set forth in claim 9, wherein said method further includes the step of oxidizing said stream subsequent to treatment in either or both of said wet scrubbing operation and said dry scrubbing operation.

11. The method as set forth in claim 1, wherein said step of oxidizing includes the use of an oxidant selected from the group consisting of hydrogen peroxide, ozone, NaClOₓ, where x is 1 through 4, or a combination thereof.

12. The method as set forth in claim 1, further including the step of reducing air toxic compounds present in said flue gas by reaction with said dry injection scrubbing operation and said wet scrubbing operation and oxidant addition.

13. A method of scrubbing SOₓ and NOₓ compounds from a flue gas stream, comprising:
a dry injection scrubbing operation and a wet scrubbing operation, said dry injection scrubbing operation including:
contacting a flue gas stream containing SOₓ and NOₓ compounds with a sorbent for removing substantially all of the SOₓ and a large amount of NOₓ compounds present in said stream;
said wet scrubbing operation including:
contacting said stream to remove any residual SOₓ and NOₓ compounds remaining in said stream; and
recirculating unreacted sorbent to said wet scrubbing operation.

14. The method as set forth in claim 13, further including the step of oxidizing said stream.

15. The method as set forth in claim 13, wherein said sodium based sorbents are selected from the group consisting of sodium based sorbents, calcium based sorbents, magnesium based sorbents and combinations thereof.

16. A method of scrubbing SOₓ and NOₓ compounds from a flue gas stream, comprising:
a dry injection scrubbing operation and a wet scrubbing operation, said dry injection scrubbing operation including:
contacting a flue gas stream containing SOₓ and NOₓ compounds with a sorbent for removing substantially all of the SOₓ and a large amount of NOₓ compounds present in said stream; and
said wet scrubbing operation including:
scrubbing said stream from said dry injection scrubbing operation in the presence of an oxidant to remove any residual SOₓ and NOₓ compounds remaining in said stream.

17. The method as set forth in claim 16, further including the step of recirculating unreacted sorbent to said wet injection scrubbing operation.

18. The method as set forth in claim 16, wherein said oxidant is selected from the group consisting of hydrogen peroxide, ozone, NaClOₓ, where x is 1 through 4, or a combination thereof.

19. The method as set forth in claim 16, wherein said stream from said dry injection scrubbing operation is exposed to oxidant.

20. The method as set forth in claim 16, wherein said stream from said dry injection scrubbing process produces sodium sulfate, sodium sulfite, sodium fluoride, sodium chloride, sodium nitrite, sodium carbonate and/or sodium nitrate.

21. A method of scrubbing SOₓ and NOₓ compounds from a flue gas stream, comprising:
a wet injection scrubbing operation and a wet scrubbing operation, said wet injection scrubbing operation including:
contacting a flue gas stream containing SOₓ and NOₓ compounds with a sorbent solution for removing substantially all of the SOₓ and a large amount of NOₓ compounds present in said stream; and
said wet scrubbing operation including:
contacting said stream to remove any residual SOₓ and NOₓ compounds remaining in said stream.

22. The method as set forth in claim 21, wherein said stream from said wet scrubbing operation is polished in a wet electrostatic precipitator.

23. the method as set forth in claim 16, wherein said stream from said wet scrubbing operation is polished in a wet electrostatic precipitator.

24. The method as set forth in claim 13, wherein said stream from said wet scrubbing operation is polished in a wet electrostatic precipitator.

25. The method as set forth in claim 22, further including removing other air toxins and fine particulate matter in said electrostatic precipitator.
